(19) United States
(12) Patent Application Publication
(10) Pub. No.: US 2012/0180669 A1
(43) Pub. Date: Jul. 19, 2012

(54) Turkish Coffee Machine

(75) Inventors: Sally Ann Lovalvo, Istanbul (TR); Caroline N. Koc, Istanbul (TR); Nil Banu Yentur, Istanbul (TR)

(73) Assignee: HAREMLIK GIDA, DEKORASYON VE EKIPMANLARI TICARET SANAYI LIMITED SIRKETI, Istanbul (TR)

(21) Appl. No.: 13/384,588

(22) PCT Filed: Apr. 19, 2010
(86) PCT No.: PCT/IB2010/051704

§ 371 Date: Apr. 2, 2012

(30) Foreign Application Priority Data
Jul. 17, 2009 (TR) 2009/05555

(51) Int. Cl. A47J 31/18

(52) U.S. Cl. 99/280

(57) ABSTRACT

The present invention relates to an automatic Turkish coffee machine which uses coffee capsules wherein loss of aroma of the coffee therein is prevented since they are airtight and which makes traditional Turkish coffee with the high pressure steam method.

### FIELD OF THE INVENTION

The present invention relates to an automatic Turkish coffee machine for making traditional Turkish coffee with coffee capsules by the high pressure steam method.

### BACKGROUND OF THE INVENTION

Turkish coffee is the name given to the method of coffee preparation and cooking invented by the Turks. It has an authentic identity with its flavor, foam, aroma, cooking and serving, and a traditional history. It is the only type of coffee served with its grounds.¹ It is one of the most preferred and consumed types of coffee in the world. ¹ Turkish Wikipedia: http://tr.wikipedia.org/wiki/T%C3%BCrk_Kahvesi

Coffee, by its very nature, starts to lose its flavor and aroma after being ground. In order to avoid this loss, the ground coffee is placed into airtight packages as rapidly as possible. However once these packages are opened, the coffee remaining in the package starts to lose its aroma. In order to overcome this problem, single use coffee capsules are used. However the available coffee capsules are not appropriate for making Turkish coffee.

Turkish coffee is made with very finely ground coffee. In traditional Turkish coffee cooking method, the coffee, adequate amount of water and desired amount of sugar are mixed in a Turkish coffeepot (cezve). While the coffeepot is heated slowly over a low flame the coffee is continued to be stirred. When the coffee is adequately heated it starts to foam. When the desired amount of foam is produced the coffee is poured into the cups and served. Making Turkish coffee this way is laborious and time consuming.

Machines are developed for making Turkish coffee more easily and rapidly. The most common type of these machines is the semi-automatic machine wherein the pot in which coffee, water and sugar are placed by the user is heated by an electrical resistance. As the said machine cooks by heating the pot, after the electricity supplied to the resistance is cut off, heat of the pot may cause the coffee to be heated for another while and to overflow. Furthermore, since the amounts of coffee, sugar and water are adjusted manually in this method, no standardization can be achieved.

In full automatic coffee machines, coffee, water and sugar are placed within the chambers in the machine and when necessary specified amounts thereof are taken, mixed and cooked. However in the said machines, the coffee goes stale when it waits too long in the chamber in the machine and can not provide the same flavor. Additionally, just like the semi automatic machines, full automatic machines also cook the coffee for another while after heating process is finished due to the temperature of the heater. This may cause the coffee to overflow. Moreover, coffee residues remain at the parts near the spout in both the full automatic and semiautomatic machines and these residues should be cleaned.

The International patent document WO2006/008583 within the state of the art discloses a machine for making Turkish coffee. The said machine operates with a semiautomatic system. Coffee and sugar are placed within a pot, and this pot is placed into the machine. Then the pot is heated, hot water is sprayed into the pot and the coffee is stirred simultaneously. When the sensor measuring the coffee level within the pot detects a rise in the level, that is to say when the coffee foams, it stops the machine. The user distributes the coffee that is in the pot into the cups and serves it. Although this system allows making coffee in large amounts, since coffee and sugar amounts are adjusted manually, it is not possible to attain the same mixture in each cup.

The Turkish patent document TR2005/02060 discloses a full automatic coffee machine. This machine receives desired amounts of coffee, sugar and water into the pot therein and stirs them by the help of a stirrer. The coffee is heated by means of the electrical resistances heating this pot and when sufficient amount of foam is produced, the electricity supplied to the resistances is cut off and the cooked coffee is poured into the cups via a pump. The coffee, sugar and water amounts used in this system are standard, however the ground coffee loses its aroma in time due to the fact that it waits in the coffee chamber within the device. Additionally there may remain coffee grounds within the pot where the coffee is cooked and in the hose used during transferring the coffee from the pot to the cup.

### SUMMARY OF THE INVENTION

The objective of the present invention is to realize a Turkish coffee machine which cooks the coffee with pressurized steam.

Another objective of the present invention is to realize a Turkish coffee machine which makes Turkish coffee by using the coffee and sugar provided in coffee capsules.

### DETAILED DESCRIPTION OF THE INVENTION

The Turkish coffee machine realized to attain the objectives of this invention is illustrated in the accompanying drawings, wherein;

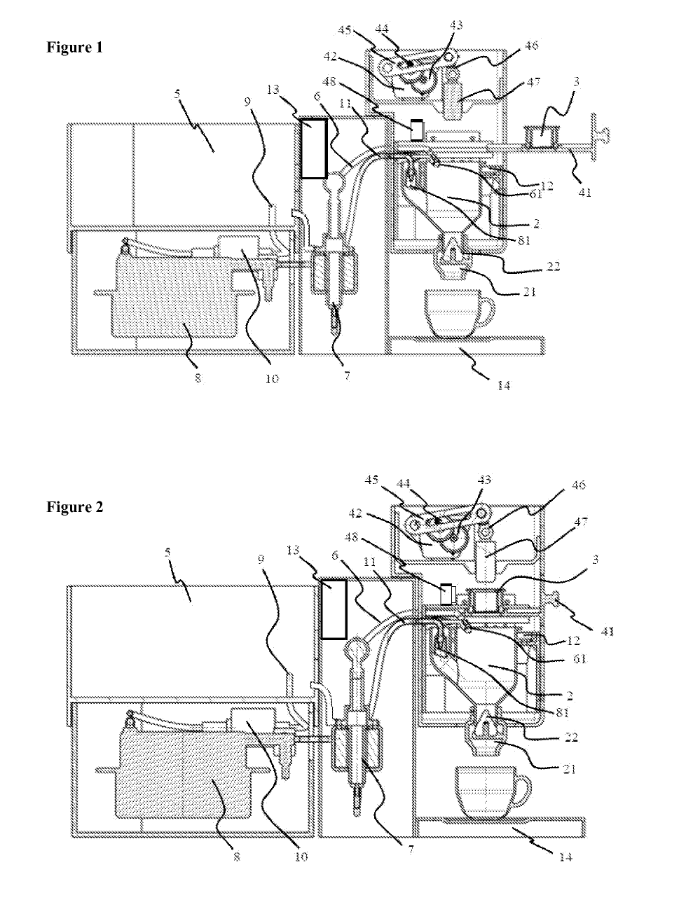

FIG. 1 is the side sectional view of the Turkish coffee machine when the capsule is placed into the capsule holder.

FIG. 2 is the side sectional view of the Turkish coffee machine when the capsule holder is closed.

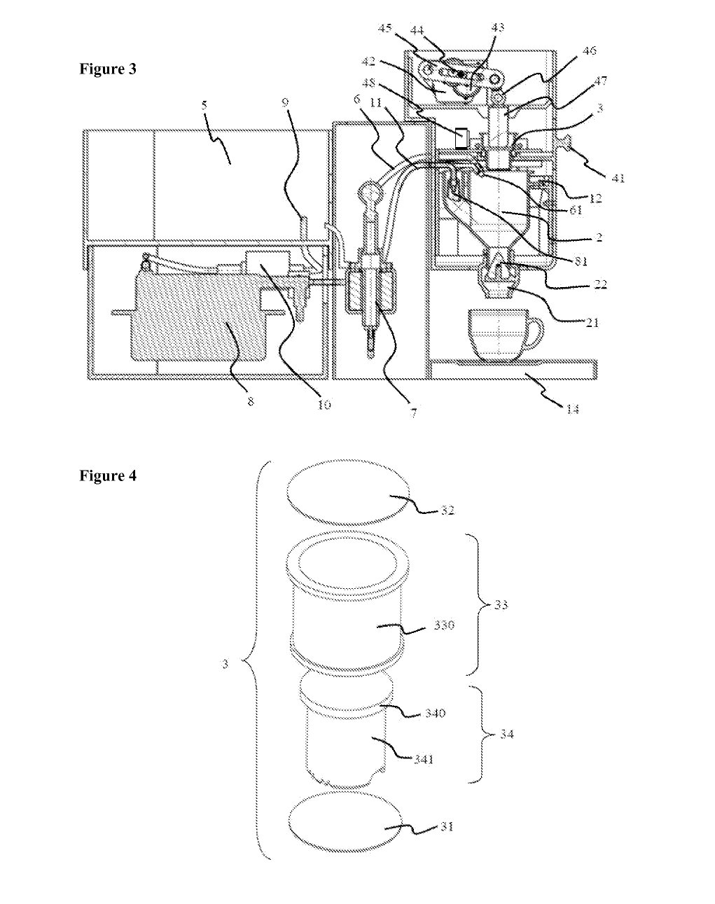

FIG. 3 is the side sectional view of the Turkish coffee machine when the capsule is punched.

FIG. 4 is the exploded perspective view of the capsule.

FIG. 5 is the side sectional view of the closed state of the capsule.

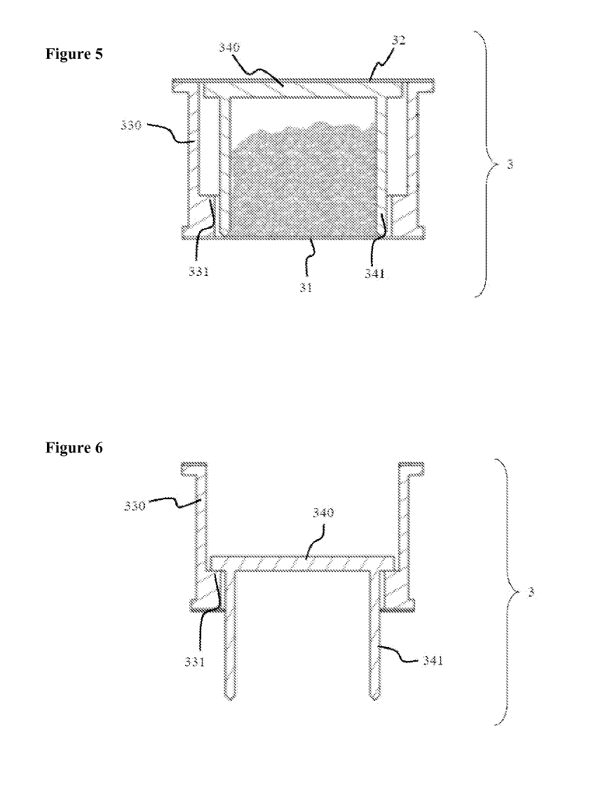

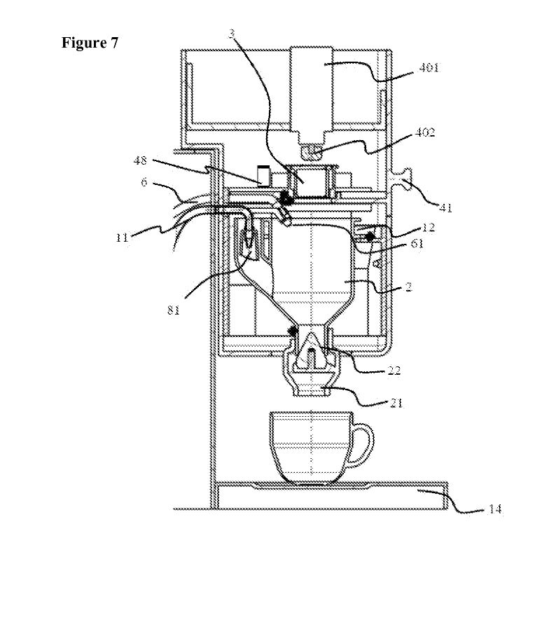

FIG. 6 is the side sectional view of the punched state of the capsule.

FIG. 7 is the side sectional view of an alternative embodiment of the Turkish coffee machine where solenoid is used when the capsule is closed.

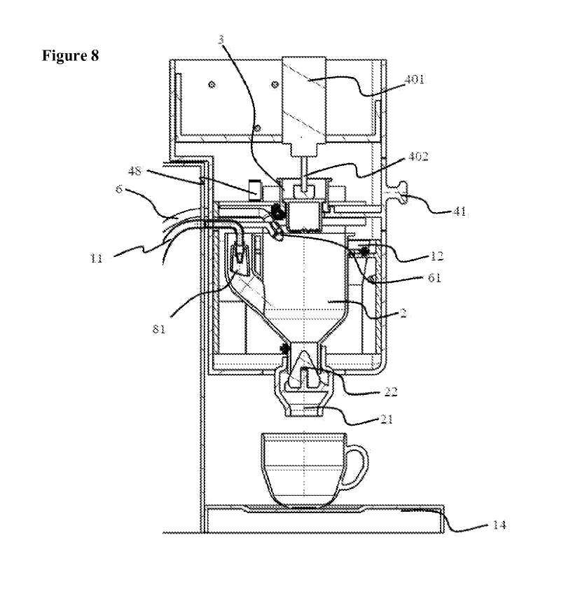

FIG. 8 is the side sectional view of an alternative embodiment of the Turkish coffee machine where solenoid is used when the capsule is punched.

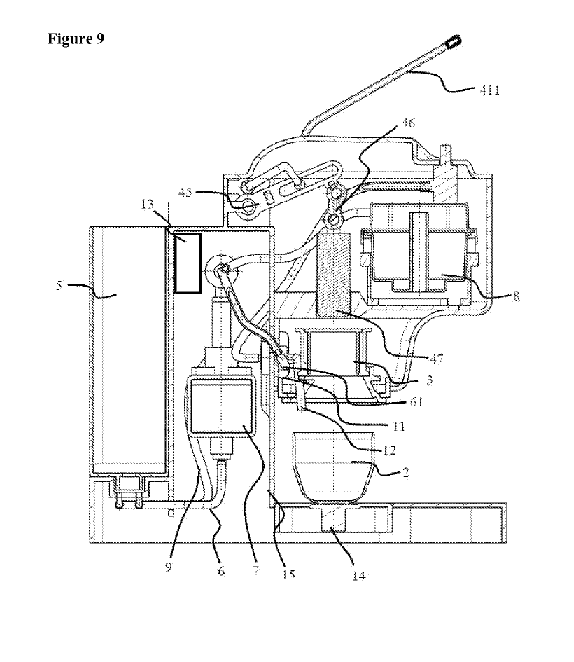

FIG. 9 is the side sectional view of an alternative embodiment of the Turkish coffee machine where manual control lever is used when the capsule is closed.

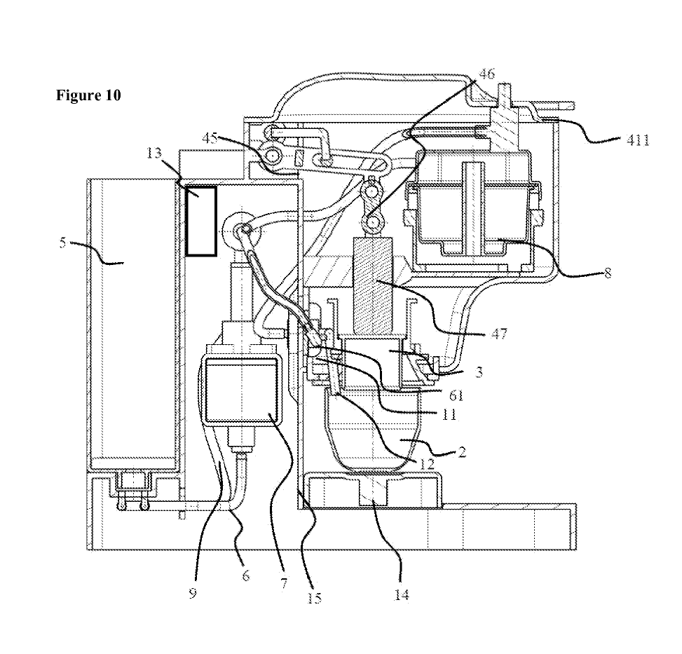

FIG. 10 is the side sectional view of an alternative embodiment of the Turkish coffee machine where manual control lever is used when the capsule is punched.

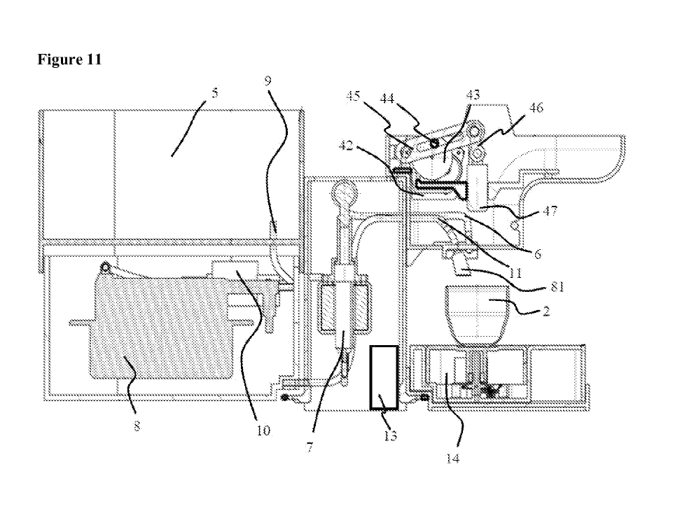

FIG. 11 is the side sectional view of an alternative embodiment of the Turkish coffee machine where the cooking chamber is located outside of the housing.

1. Turkish coffee machine
2. Cooking chamber
   21. Outlet part
   22. Lid
3. Capsule
   31. Lower film
   32. Upper film
   33. Outer body
      330. Wall
      331. Extension
   34. Inner body
      340. Ceiling
      341. Protrusion
4. Capsule punching mechanism
   41. Capsule holder
   42. Motor
   43. Gear pair
   44. Pin
   45. Level arm
   46. Connecting member
   47. Punch arm
   48. Switch
   401. Solenoid
   402. Punch pin
   411. Control lever
5. Water tank
6. Cold water hose
   61. Water nozzle
7. Cold water pump
8. Steam boiler
   81. Steam nozzle
9. Steam boiler hose
10. Steam boiler pump
11. Steam hose
12. Sensor
13. Controller
14. Coffee cup section
15. Housing

The inventive Turkish coffee machine (1) comprises
at least one cooking chamber (2) in the form of a pot in which the coffee is cooked and which comprises an outlet part (21) and a lid (22) at the lower end thereof,
at least one capsule (3) which includes the coffee and sugar that will be brewed,
a capsule punching mechanism (4) which punches the capsule (3) whereby enabling its content to be poured into the cooking chamber (2),
at least one water tank (5) in which the water required to generate steam and to make the coffee is placed,
at least one cold water hose (6) which conveys the water in the water tank (5) to the cooking chamber (2),
at least one cold water pump (7) which pumps the water in the water tank to the cold water hose (6),
at least one steam boiler (8) which boils the water whereby enabling to obtain high pressure steam,
at least one steam boiler hose (9) which conveys the water in the water tank (5) to the steam boiler (8),
at least one steam boiler pump (10) which pumps the water to the steam boiler (8) by increasing the pressure of the flow within the steam boiler hose (9),
a steam hose (11) which conveys the steam obtained in the steam boiler (8) to the cooking chamber (2),
a sensor (12) which measures the increase in the level of the coffee being cooked in the cooking chamber (2),
a controller (13), which, when the level information coming from the sensor (12) reaches the intended value, cuts off the flow in the steam hose (11), opens the lid (22) on the lower surface of the cooking chamber (2) and pours the coffee into the cup,
a coffee cup section (14) where the cup with which the cooked coffee will be served is placed and
a housing (15) surrounding all of the parts.

The cooking chamber (2) serves as a pot in which the coffee is cooked. In the preferred embodiment of the invention, the cooking chamber (2) is in the form of a cylinder whose lower part tapers downwards. There is an opening on the upper surface of the cooking chamber (2). Coffee and sugar are introduced into the cooking chamber (2) from the said opening. The steam hose (11) and the cold water hose (6) are connected to the upper part of the cooking chamber (2). There is a lid (22) on the lower surface of the cooking chamber (2) which enables the cooked coffee to be transferred from the cooking chamber (2) to the cup. Below the lid (22) there is an outlet part (21) which enables the coffee to be poured into the cup smoothly.

The capsule (3) is preferably cylindrical but can also be in different forms. It comprises an outer body (33) whose lower surface is coated with a lower film (31) and upper surface with an upper film (32), and an inner body (34) adapted to move within the outer body (33). The outer body (33) has a wall (330) surrounding the capsule (3) and an extension (331) at the lower end of the inner surface of the wall (330). The inner body (34) is placed within the outer body (33) concentrically. There is a circular ceiling (340) on the upper surface of the inner body (34). The ceiling (340) is narrower than the inner diameter of the wall (330) so that it can move within the wall (330), and wider than the inner diameter of the extension (331) so that it does not fall down to the bottom of the capsule. There is a cylindrical protrusion (341) in the inner body (34) integral with the ceiling (340) and having a smaller diameter than the extension (331) (FIG. 5). This way, the inner body (34) can move within the outer body (33) but it does not fall down into the cooking chamber (2) since it gets caught by the extension (331) (FIG. 6).

The lower end of the protrusion (341) is sharp, tapering to punch the film (31). Additionally there are recesses at the lower end of the protrusion (341). When the protrusion (341) is pushed towards the lower film (31) the parts where there is no recess punch the lower film (31), but because the parts corresponding to the recesses are not torn, the lower film (31) does not fall down to the cooking chamber (2). The lower film (31) is fixed to the bottom of the wall (330) of the outer body (33) and contacts the lower end of the protrusion (341). The upper film (32) is fixed to the top of the wall (330) and contacts the upper surface of the ceiling (340). The lower film (32) and the upper film (32) are made of a thin and flexible material, preferably of aluminum foil. The roasted and ground coffee and sugar mixture is located within the protrusion (341) on the lower film (31). The lower film (31) and the upper film (32) are airtight whereby loss of aroma of the coffee in time is prevented. Within the capsule (3) there may be placed mixtures of plain coffee or coffee with aromatic flavors like chocolate, cinnamon, cardamom, gum mastic, mint, etc. with no sugar, little sugar, medium sugar or a lot of sugar.

The capsule punching mechanism (4) comprises
at least one capsule holder (41) on which the capsule (3) is placed when being inserted into the Turkish coffee machine (1), and which has an aperture in the center thereof wider than the protrusion (341) of the inner body (34) and narrower than the wall (330) of the outer body (33) and which can be opened and closed by means of a rail mechanism,
at least one motor (42) which provides the power required to punch the capsule (3),
a gear pair (43) comprising at least one gear that reduces the speed of the movement obtained by the motor (42),
a pin (44) which is located on one of the gears in the gear pair (43) and which is not concentric with the said gear,
a level arm (45) in the form of a rod, which is fixed at one end thereof, comprises an opening in the middle thereof in which the pin (44) may move back and forth, and moves circularly around the axis of its fixed end with the movement of the pin (44),
at least one connecting member (46) which diverts the movement of the level arm (45) to vertical direction,
a punch arm (47) connected to the connecting member (46) which can move only in the vertical axis and punches the capsule (3) whereby enabling the coffee in the capsule (3) to be poured into the cooking chamber (2) through the aperture in the capsule holder (41), and
at least one switch (48) which is turned off when the capsule holder (41) is open, and which is turned on when the capsule holder (41) is closed whereby operating the motor (42). The capsule punching mechanism is located above the cooking chamber (2). When the capsule holder (41) is closed it closes the opening on top of the cooking chamber (2).

The water tank (5) is the container where the water to be used is stored. When the amount of water in the water tank (5) decreases, water can be added to it through the lid on top it. One end of both the cold water hose (6) and the steam boiler hose (9) are located within the water tank (5) somewhere near the base.

The cold water pump (7) conveys the water it takes from the water tank into the cooking chamber (2) by high pressure via the cold water hose (6). The cold water hose (6) is preferably flexible. There is provided a water nozzle (61) at the end of the cold water hose (6) facing the cooking chamber (2) for spraying the water.

In the preferred embodiment of the invention, the steam boiler (8) is located under the water tank (5). However since water is conveyed to the steam boiler (8) via the steam boiler hose (9) the steam boiler (8) can be disposed in different locations. The steam boiler (8) boils the water therein by using electric energy and enables obtaining high pressure steam. Because of the high pressure in the steam boiler (8), in order to be able to add water to the steam boiler (8), the water should be conveyed by a pressure higher than the pressure in the boiler (8). The steam boiler pump (10) enables to obtain the said water pressure. The steam boiler pump (10) is connected to the steam boiler hose (9) which conveys the water that it takes from the water tank (5) to the steam boiler. One end of the steam hose (11) is connected to the cooking chamber (2) while the other is to the steam boiler (8). The pressure steam obtained in the steam boiler (8) is conveyed to the cooking chamber (2) via the steam hose (11).

There is provided a steam nozzle (81) at the end of the steam hose (11) entering into the cooking chamber (2) intended for preventing the pressure steam coming from the steam boiler (8) during cooking from causing the water and coffee mixture to overflow. The said nozzle (81) imprisons the air bubbles of the pressure steam coming from the steam boiler (8) whereby enabling them to be discharged through the air holes thereon, prevents the coffee from splashing during cooking, and prevents it from overflowing from the cooking chamber (2).

The sensor (12) is arranged such that it detects the level of the coffee being cooked within the cooking chamber (2). This level information is transferred to the controller (13) to which the sensor (12) is connected. When the level in the information received from the sensor (12) reaches the predetermined sufficient foam level, the controller (13) cuts off the steam flow in the steam hose (11) and opens the lid (22) under the cooking chamber (2).

The coffee cup section (14) is located below the outlet part (21). A coffee cup is placed here and as the lid (22) opens, the cooked coffee is poured down to the cup.

The housing (15) keeps the units within the Turkish coffee machine (1) together and surrounds all the units to protect them against the external factors.

The Turkish coffee machine (1) starts to operate after the capsule (3) is placed on the open capsule holder (41) and the capsule holder (41) is closed. Then the switch (48) is turned on to operate the motor (42). Upon operation of the motor (42), the gear pair (43) rotates. With the said rotation, the pin (44) on the last gear makes a circular movement. By means of the circular movement of the pin (44), the level arm (45) rotates around the axis of its fixed end. To the other end of the level arm (45) is connected one end of the connecting member (46). The other end of the connecting member (46) is connected to the punch arm (47) which can move only in vertical axis. Rotation of the level arm (45) enables the punch arm (47) to move in the vertical axis. During this movement thereof the punch arm (47) contacts the upper film (32) of the capsule (3) which is located right below it and pushes the ceiling (340) under the upper film (32) and thus the inner body (34) downwards. As the inner body (34) moves downwards, the protrusion (341) punches the lower film (31). The inner body (34) continues to move downwards until the ceiling (340) contacts the extension (331). As the lower film (341) is punched, the coffee in the capsule (3) is poured into the cooking chamber (2). Then, as the motor (42) movement continues, the punch arm (47) returns to its initial position. When the cold water pump (7) starts to operate, water is sprayed onto the coffee, which is poured into the cooking chamber (2), from the water nozzle (61) at the end of the cold water hose (6). In the meantime, steam is obtained by boiling the water in the steam boiler (8). When the steam pressure reaches the predetermined level, high pressure steam is applied on the wetted coffee through the steam nozzle (81) at the end of the steam hose (11). The coffee is cooked by means of the heat of this steam. When the coffee is cooked sufficiently it starts to foam and the level of the coffee increases. Once the sensor (12) detects this level increase, the controller (13) cuts off the steam flow and opens the lid (22) after a predetermined period of time. When the lid (22) is opened, the coffee flows through the outlet part (21) and is poured down to the coffee cup placed on the coffee cup section (14) by the user.

In an alternative embodiment of the invention, the cooking chamber (2) is positioned outside of the housing (15), at the location of the coffee cup section (14). In this embodiment, the coffee is again prepared within the cooking chamber (2) but there is no lid (22) or outlet part (21) at the base of the cooking chamber. In order to prevent the coffee from overflowing due to high pressure during this application, the cooking chamber (2) is raised via a mechanism and arranged such that it will contact the surface to which the steam and water are sprayed (FIG. 11). After the coffee is prepared in the cooking chamber (2), the cooking chamber is lowered. As the coffee can be distributed by the user to the cups at desired amounts, a plurality of cups of coffee can be made concurrently in this alternative embodiment. In this embodiment, when a plurality of cups of coffee is desired to be made, the capsule (3) to be used should also include higher volumes of coffee.

In another embodiment of the invention where the cooking chamber (2) is outside of the housing (15), the capsule punching mechanism (4) is controlled manually. In the said embodiment, there is a control lever (411) on the housing (15), and a spring in between the control lever (411) and the housing (15). As the control lever (411) is rotated downwards the spring is compressed and the punch arm (47) punches the capsule (3). Then, due to the pushing force of the spring, the control lever (411) moves upwards returning to its initial position (FIG. 9).

In another embodiment of the invention, an electromechanical solenoid (401) and a punch pin (402) are used instead of the capsule punching mechanism (4) (FIG. 7). The motor (42) gear pair (43), pin (44), level arm (45), connecting member (46) and the punch arm (47) are not required. In the said embodiment, when the switch (48) is turned on, the solenoid (401) becomes active and pushes the punch pin (402) downwards, that is, towards the upper film (32) of the capsule. After a sufficient period of time for the coffee to be poured, the solenoid (401) pulls the punch pin (402) back upwards.

Within the scope of these basic concepts, it is possible to develop a wide variety of the inventive Turkish coffee machine (1). The invention cannot be limited to the examples described herein. It is essentially according to the claims.

1. A Turkish coffee machine (1) comprising
at least one cooking chamber (2) in the form of a pot in which the coffee is cooked,
at least one capsule (3) which includes the coffee and sugar that will be brewed,
a capsule punching mechanism (4) which punches the capsule (3) whereby enabling its content to be poured into the cooking chamber (2),
at least one water tank (5) in which the water required to generate steam and to make the coffee is placed,
at least one cold water hose (6) which conveys the water in the water tank (5) to the cooking chamber (2),
at least one cold water pump (7) which pumps the water in the water tank to the cold water hose (6),
at least one steam boiler (8) which boils the water whereby enabling to obtain high pressure steam,
at least one steam boiler hose (9) which conveys the water in the water tank (5) to the steam boiler (8),
at least one steam boiler pump (10) which pumps the water to the steam boiler (8) by increasing the pressure of the flow within the steam boiler hose (9),
a steam hose (11) which conveys the steam obtained in the steam boiler (8) to the cooking chamber (2),
a sensor (12) which detects the level of the coffee being cooked, a coffee cup section (14) where the cup with which the cooked coffee will be served is placed,
a housing (15) which keeps all the units together and surrounds them to protect them against external factors;
characterized by
at least one cooking chamber (2) which has a lid (22) at its lower surface and cooks the coffee therein with pressurized steam and water provided through its upper surface, and
a controller (13), which, when the level information coming from the sensor (12) reaches the intended value, cuts off the steam flow in the steam hose (11), opens the lid (22) on the lower surface of the cooking chamber (2) and pours the coffee into the cup.

2. A Turkish coffee machine (1) according to claim 1, characterized by a capsule (3) comprising
a lower film (31) and an upper film (32) made of a thin and flexible material coating the lower and upper surfaces,
an outer body (33) having a preferably cylindrical wall (330) and an extension (331) at the lower end of the inner surface of the wall (330),
an inner body (34) arranged in the outer body (33) concentrically and having a circular ceiling (340) on its upper surface and a cylindrical protrusion (341) integral with the said ceiling (340);
in which capsule (3) the coffee and sugar mixture is located between the protrusion (341), ceiling (340) and the lower film (31).

3. A Turkish coffee machine (1) according to claim 2, characterized by a capsule (3) comprising a ceiling (340) which is narrower than the inner diameter of the wall (330) so that the inner body (34) can move within the outer body (33), and wider than the inner diameter of the extension (331) so that the inner body (34) does not fall down to the cooking chamber (2).

4. A Turkish coffee machine (1) according to claim 2, characterized by a capsule (3) which enables the coffee to be poured down to the cooking chamber (2) when the protrusion (341) punches the lower film (31) after the ceiling (340) is pushed towards the lower film (31).

5. A Turkish coffee machine (1) according to claim 2, characterized by a capsule (3) comprising a cylindrical protrusion (341), which has a smaller diameter than the extension (331), a sharp lower end for punching the lower film (31), and recesses at its lower end preventing the lower film (31) from getting completely torn.

6. A Turkish coffee machine (1) according to claim 1, characterized by a capsule punching mechanism (4) comprising
at least one capsule holder (41) on which the capsule (3) is placed when being inserted into the Turkish coffee machine (1), and which has an aperture in the center thereof wider than the protrusion (341) of the inner body (34) and narrower than the wall (330) of the outer body (33) and which can be opened and closed by means of a rail mechanism,
at least one motor (42) which provides the power required to punch the capsule (3),
a gear pair (43) comprising at least one gear that reduces the speed of the movement obtained by the motor (42),
a pin (44) which is located on one of the gears in the gear pair (43) and which is not concentric with the said gear,
a level arm (45) in the form of a rod, which is fixed at one end thereof, comprises an opening in the middle thereof in which the pin (44) may move back and forth, and moves circularly around the axis of its fixed end with the movement of the pin (44),
at least one connecting member (46) which diverts the movement of the level arm (45) to vertical direction,
a punch arm (47) connected to the connecting member (46) which can move only in the vertical axis and punches the capsule (3) whereby enabling the coffee in the capsule (3) to be poured into the cooking chamber (2) through the aperture in the capsule holder (41), and
at least one switch (48) which is turned off when the capsule holder (41) is open, and which is turned on when the capsule holder (41) is closed whereby operating the motor (42).

7. A Turkish coffee machine (1) according to claim 1, characterized by at least one solenoid (401), which is used in an alternative embodiment of the invention in place of the capsule punching mechanism (4), and which enables the capsule (3) to be punched by pushing the punch pin (402) against the upper film (32) of the capsule (3).

8. A Turkish coffee machine (1) according to claim 1, characterized by a cooking chamber (2), which is positioned outside of the housing (15) and on the coffee cup section (14) in an alternative embodiment of the invention, cooks the coffee therein with pressurized steam and water provided through its upper surface, and enables to make a plurality of cups of coffee concurrently as the coffee that is cooked therein is distributed by the user to the cups.

9. A Turkish coffee machine (1) according to claim 1, characterized by a control lever (411) which enables the capsule punching mechanism (4) that punches the capsule (3) to be operated by a user in an alternative embodiment of the invention.
